(19) United States
(12) Patent Application Publication
(10) Pub. No.: US 2016/0376839 A1
(43) Pub. Date: Dec. 29, 2016

(54) Cord-winding Device for a Window Blind Capable of Rapidly Winding and Unwinding a Cord

(71) Applicant: Ya-Ling Huang, Taichung City (TW)

(72) Inventor: Ya-Ling Huang, Taichung City (TW)

(21) Appl. No.: 15/176,243

(22) Filed: Jun. 8, 2016

(30) Foreign Application Priority Data
Jun. 24, 2015 (TW) 104210120

(51) Int. Cl. E06B 9/322; E06B 9/323

(52) U.S. Cl. CPC E06B 9/322; E06B 9/323

(57) ABSTRACT

A cord-winding device for a window blind includes a base unit having a base defining a slide channel. An adjustment unit includes two slide seats mounted in the slide channel and slidable toward or away from each other, two sets of pulleys mounted respectively and rotatably on the slide seats, at least one elastic unit disposed on one of the slide seats, and an adjustment cord winding around the sets of pulleys and then extending through the base. The adjustment cord is configured to be connected to the window blind after extending through the base, and is configured to support the weight of the window blind to thereby generate a pulling force to pull the slide seats.

### CROSS REFERENCE TO RELATED APPLICATION

This application claims priority of Taiwanese Patent Application No. 104210120, filed on Jun. 24, 2015.

### FIELD

The disclosure relates to a window blind, more particularly to a cord-winding device for a window blind that is capable of rapidly winding and unwinding a cord.

### BACKGROUND

Referring to FIG. 1, a conventional window blind includes a support frame 11, a blind body 12 connected to the support frame 11, a slide seat 13 mounted slidably on the support frame 11, two sets of pulleys 14 mounted rotatably and respectively on the support frame 11 and the slide seat 13, a tension spring 15 connected between the support frame 11 and the slide seat 13, and a lift cord 16 having two cord end sections that extend parallel to each other, that wind through the sets of pulleys 14, that extend respectively through through holes in the support frame 11, and that extend through slats of the blind body 12 and finally, are fixed to a bottom end of the blind body 12. When an external force is applied to the bottom end of the blind body 12, the lift cord 16 is driven to move, the pulleys 14 are driven to rotate and the slide seat 13 is driven to slide, so that the tension spring 15 is stretched or retracted to lower or raise the blind body 12. The effect of adjusting the blind body 12 having no pull cord can thus be achieved.

However, the tension spring 15 requires a sufficient tension space. If the space is too short, the elastic force of the tension spring 15 will be insufficient; and if the space is too long, it will result in elastic fatigue of the tension spring 15. The length of the support frame 11 is thus restricted, and it is not convenient to mount a plurality of the tension springs 15. Further, when the tension spring 15 is stretched, the length and the elastic force thereof are increased, and a big difference in the tensile strength thereof before and after stretching may occur, so that the tension spring 15 may not be able to balance with the weight of the blind body 12. Moreover, the lower the blind body 12 is pulled, the more the effort must be exerted. The speed of adjusting the length of the blind body 12 is slow. Hence, the conventional window blind is inconvenient to use.

### SUMMARY

Therefore, an object of the disclosure is to provide a cord-winding device for a window blind that is capable of overcoming the aforesaid drawback of the prior art.

According to the disclosure, a cord-winding device for a window blind includes a base unit and a first adjustment unit. The base unit includes a base that extends along a longitudinal direction and that defines a slide channel. The base has a bottom surface configured to removably abut against the window blind. The slide channel extends along the length of the base. The first adjustment unit includes two first slide seats mounted in the slide channel and slidable toward or away from each other along the longitudinal direction, two sets of first pulleys mounted respectively and rotatably on the first slide seats, at least one first elastic unit disposed on one of the first slide seats, and a first adjustment cord winding around the sets of first pulleys and then extending through the base. The first adjustment cord is configured to be connected to the window blind after extending through the base, and is configured to support the weight of the window blind to thereby generate a pulling force to pull the first slide seats.

When the first adjustment cord pulls the first slide seats, the first slide seats move toward each other and pull the at least one first elastic unit so as to generate a resilient restoring force that counteracts the pulling force of the first adjustment cord and achieve a force-balanced state. When an external force is applied to the window blind, the force-balanced state is changed for adjusting an extended or retracted length of the window blind.

### BRIEF DESCRIPTION OF THE DRAWINGS

Other features and advantages of the disclosure will become apparent in the following detailed description of the embodiments with reference to the accompanying drawings, of which:

FIG. 1 isasectional view of a conventional window blind;

FIG. 2 is an exploded perspective view of a cord-winding device according to the first embodiment of the present disclosure and a window blind;

FIG. 3 is a fragmentary sectional view, illustrating two first slide seats of a first adjustment unit of the first embodiment in a first position;

FIG. 4 is a sectional top view of FIG. 3;

FIG. 5 is another fragmentary sectional view, illustrating the first slide seats of the first adjustment unit in a second position;

FIG. 6 is a sectional top view of FIG. 5;

FIG. 7 is an exploded perspective view of a cord-winding device according to the second embodiment of the present disclosure and a window blind;

FIG. 8 is a fragmentary sectional view, illustrating two first slide seats of a first adjustment unit of the second embodiment in a first position;

FIG. 9 is a sectional top view of FIG. 8;

FIG. 10 is another fragmentary sectional view, illustrating the first slide seats of the first adjustment unit in a second position;

FIG. 11 is a sectional top view of FIG. 10;

FIG. 12 is an exploded perspective view of a cord-winding device according to the third embodiment of the present disclosure and a window blind;

FIG. 13 is a fragmentary sectional view, illustrating a first adjustment unit and a second adjustment unit of the third embodiment;

FIG. 14 is a sectional top view of FIG. 13;

FIG. 15 is another fragmentary sectional view, illustrating the first and second adjustment units being adjusted to place a blind in a partially lowered position; and

FIG. 16 is a sectional top view of FIG. 15.

### DETAILED DESCRIPTION

Before the present disclosure is described in greater detail, it should be noted herein that like elements are denoted by the same reference numerals throughout the disclosure.

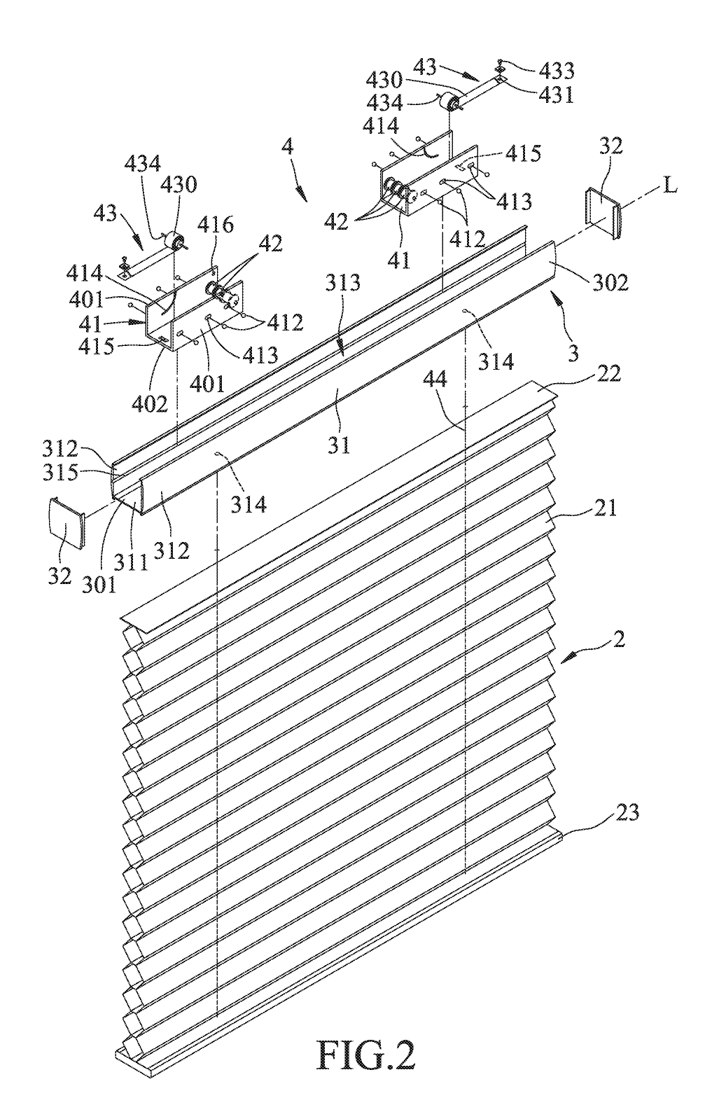

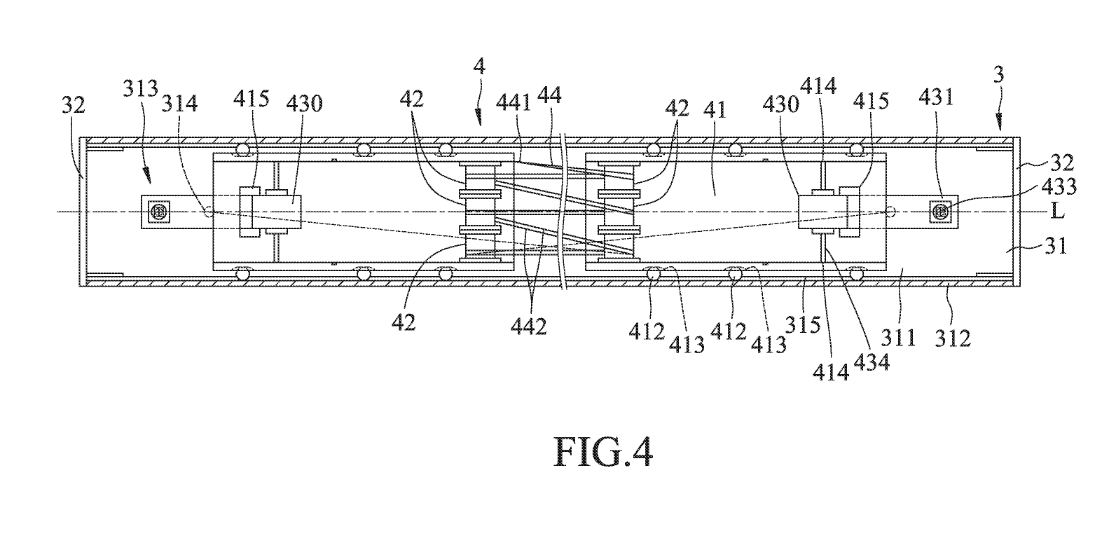

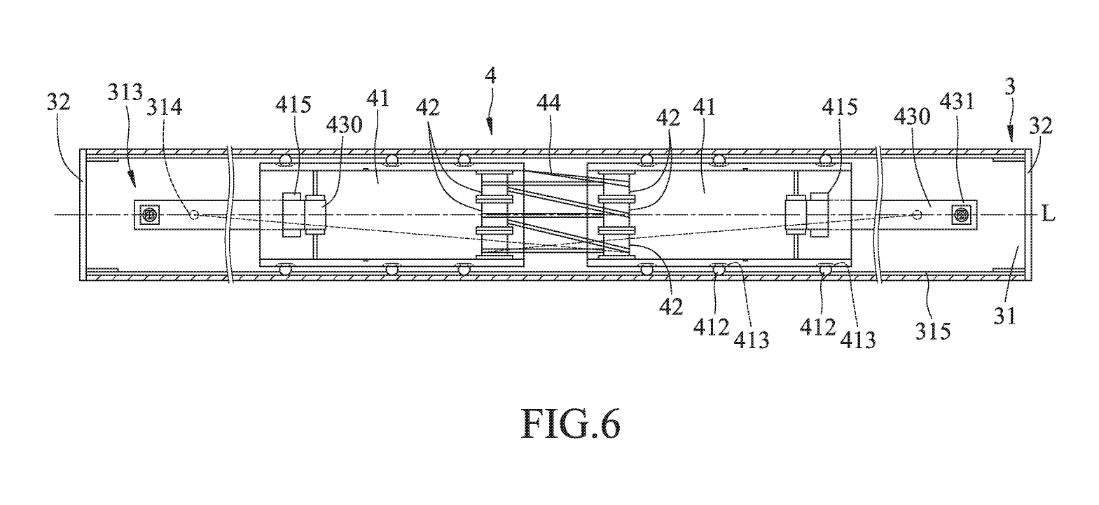

Referring to FIGS. 2 to 6, a cord-winding device according to the first embodiment of the present disclosure is configured to be connected to a window blind 2. The window blind 2 includes a blind body 21, a top plate 22 disposed on a top edge of the blind body 21, and a bottom plate 23 disposed on a bottom edge of the blind body 21. The window blind 2 may be a Roman blind, a cellular blind, a pleated blind, a Venetian blind, or any other style of window blind that can be raised and lowered. The cord-winding device of the first embodiment includes a base unit 3 and a first adjustment unit 4.

The base unit 3 includes a base 31 extending along a longitudinal direction (L), and two end caps 32 respectively covering two opposite longitudinal ends 301, 302 of the base 31. The base 31 includes a base bottom wall 311 extending along the longitudinal direction (L), and two base side walls 312 extending upwardly and respectively from two opposite lateral ends of the base bottom wall 311. The base bottom wall 311 and the base side walls 312 cooperate to define a slide channel 313 extending along the length of the base 31. The base bottom wall 311 has a bottom surface configured to removably abut against the top plate 22, and two through holes 314 extending therethrough in a top-bottom direction transverse to the longitudinal direction (L) and spaced apart from each other along the longitudinal direction (L). The base side walls 312 respectively have slide rails 315 parallel and aligned with each other. Each slide rail 315 is in the form of a slide groove that extends along the length of a respective one of the side walls 312.

The first adjustment unit 4 includes two first slide seats 41, two sets of first pulleys 42, two first elastic units 43, and a first adjustment cord 44. The first slide seats 41 are spacedly disposed in the slide channel 313, and are slidable toward or away from each other along the longitudinal direction (L). Each of the first slide seats 41 includes two opposite slide side walls 401, a slide bottom wall 402 connected between bottom ends of the slide side walls 401, and a plurality of roller balls 412. The slide bottom wall 402 is formed with a limiting hole 415 extending therethrough and proximate to one end thereof. Each of the slide side walls 401 has an inner surface formed with an engaging groove 414, and an outer surface formed with a plurality of elongated recesses 413 that are spaced apart from each other in the longitudinal direction (L) along the length thereof. The engaging grooves 414 of the slide side walls 401 are symmetrically aligned with each other. Each roller ball 412 has a portion received in a respective one of the recesses 413 of a corresponding one of the first slide seats 41, and another portion received in the slide rail 315 of a corresponding one of the base side walls 412. Through this, the roller balls 412 are rollable along the slide rails 315 of the base side walls 412 to limit the sliding movement of the slide seats 41 along the longitudinal direction (L).

The two sets of first pulleys 42 are mounted respectively and rotatably on the first slide seats 41. Specifically, each set of first pulleys 42 includes three first pulleys 42 that are coaxially and rotatably mounted on each first slide seat 41. The first pulleys 42 of each first slide seat 41 are disposed side by side in a direction transverse to the longitudinal direction (L) and face the first pulleys 42 of the other first slide seat 41.

Each of the first elastic units 43 includes a first elastic member 430, a fastener 433 and a pivot shaft 434. The first elastic member 430 is a constant force spiral spring which has a characteristic that is suitable for use in a small space and which can provide a constant elastic force within an effective length of travel. Furthermore, because the first elastic member 430 is a rolled spring, it is less likely to produce friction when stretched so as to ensure its smooth operation. The first elastic member 430 has a first end 431 fixed to the base bottom wall 311, and a second end 432 opposite to the first end 431. The pivot shaft 434 of each elastic unit 43 has two opposite ends engaged respectively, slidably and rotatably to the engaging grooves 414 of the slide side walls 401 of the corresponding first slide seat 41. The second end of the first elastic member 430 is wound around and fixed to the pivot shaft 434.

The first elastic members 430 of the first elastic units 43 are respectively proximate to the end caps 32. The first end 431 of the first elastic member 430 of each first elastic unit 43 extends through the limiting hole 415 in the slide bottom wall 402 of the corresponding first slide seat 41 so as to be fixed to the base bottom wall 311 by the fastener 433. The limiting holes 415 in the slide bottom walls 402 of the first slide seats 41 can prevent rotation of the first elastic members 430. Further, in coordination with the sliding movement of the first slide seats 41 along the longitudinal direction (L), movement and force output of the first elastic members 430 along the longitudinal direction (L) are also ensured. The first elastic members 430 can be wound or unwound according to the sliding movements of the first slide seats 41.

The first adjustment cord 44 has a fixed intermediate section 441, and two cord end sections 442 extending outwardly and respectively from two opposite ends of the fixed intermediate section 441. In this embodiment, one of the slide side walls 402 of one of the first slide seats 41 further has an orifice 416 formed through the inner and outer surfaces thereof, and the slide bottom wall 402 of the one of the first slide seats 41 is further formed with a passage hole 417 for extension of the cord end sections 442 therethrough. The fixed intermediate section 441 is fixed to the orifice 416. The cord end sections 442 extend parallel to each other, are wound around the sets of first pulleys 42, and then extend through the passage hole 417. After passing through the passage hole 417, the cord end sections 442 extend through the respective through holes 314 in the base bottom wall 311, the top plate 22, the blind body 21 and, finally, are fixed to the bottom plate 23. The bottom plate 23 changes its height and position through the pulling of the first adjustment cord 44, and drives the blind body 21 to retract or extend.

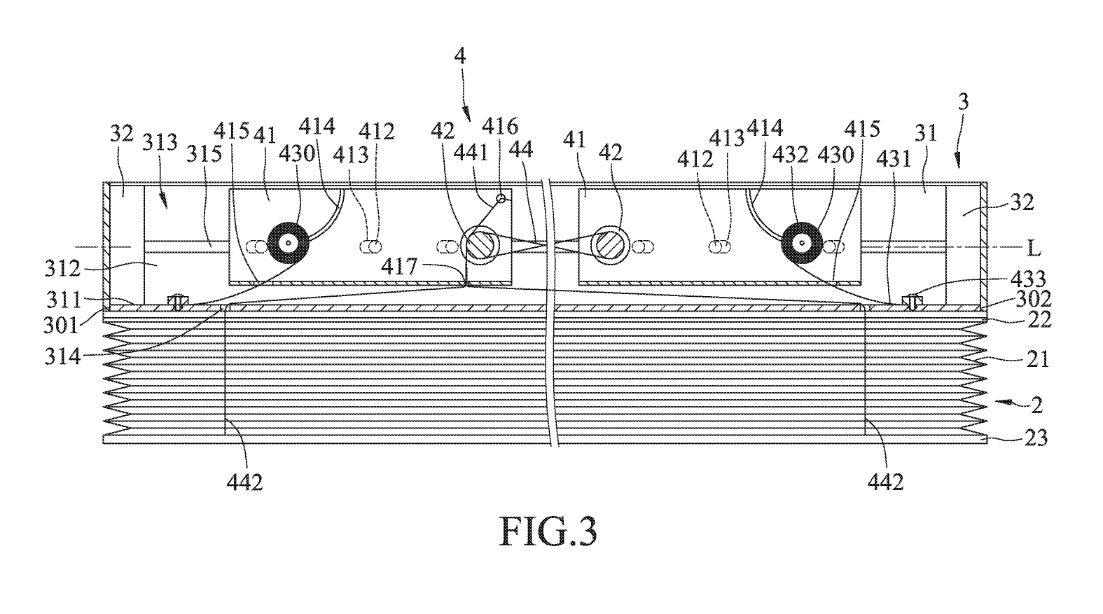

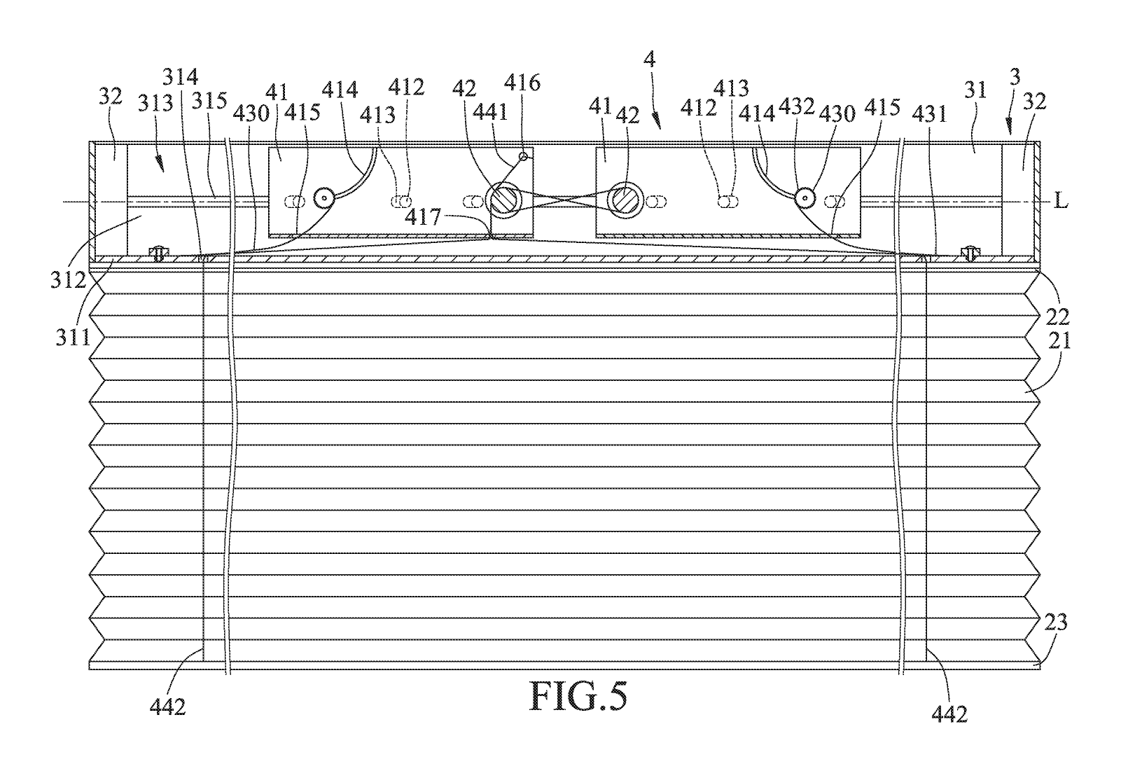

With reference to FIGS. 3 to 6, the first slide seats 41 are movable relative to the base 31 between a first position and a second position. The extent of the retracted or extended length of the blind body 21 is determined by the released length of the cord end sections 442 of the first adjustment cord 44. Therefore, by changing the position of the first slide seats 41, the retracted or extended length of the cord end sections 442 of the first adjustment cord 44 can be adjusted so as to raise or lower the blind body 21. In the first position, as shown in FIG. 3, the first slide seats 41 are spaced apart from each other and are proximate to the respective end caps 32, and major portions of the cord end sections 442 of the first adjustment cord 44 are wound around the first pulleys 42 of the corresponding first slide seats 41, so that the blind body 21 is retracted upwardly and tightly abuts against the bottom surface of the base bottom wall 311 so as to place the window blind 2 in a retracted or raised position. In the second position, as shown in FIG. 5, the first slide seats 41 are proximate to each other and are distal from the respective end caps 32, and the cord end sections 442 of the first adjustment cord 44 are unwound from the first pulleys 42 of the corresponding first slide seats 41, so that the blind body 21 is extended downwardly and completely so as to place the window blind 2 in an extended or lowered position.

In a normal state of use, the base unit 3 is fixed to a window, and the window blind 2 is in the lowered position. The first adjustment cord 44 supports the weight of the window blind 2, and generates a pulling force that pulls the first slide seats 41. The first slide seats 41, in turn, pull the first elastic members 430 so that each first elastic member 430 generates a resilient restoring force. The resilient restoring forces of the first elastic members 430 counteract the pulling force of the first adjustment cord 44 to achieve a force-balanced state, so that movements of the first slide seats 41 are stopped or arrested. It is worth to mention herein that, in the absence of an external force, regardless of the amount of stretching of the first elastic members 430, the resilient restoring forces thereof are constant and remain balanced with the pulling force of the first adjustment cord 44. Thus, the first slide seats 41 can remain at any location between the first and second positions, and the blind body 21 can also remain at a suitable length.

When it is desired to lower the window blind 2 to block sunlight, an external force is applied to pull down the bottom plate 23 of the window blind 2 so as to increase the pulling force of the first adjustment cord 44 and resist the resilient restoring forces of the first elastic members 430. Simultaneously, the first slide seats 41 are pulled to move toward each other, and the distance between the first pulleys 42 of the first slide seats 41 is shortened, thereby rapidly unwinding the cord end sections 442 of the first adjustment cord 44 from the first pulleys 42 until the bottom plate 23 is lowered and the blind body 21 is extended downwardly. After the external force is released, the resilient restoring forces of the first elastic members 430 are again balanced with the pulling force of the first adjustment cord 44 to thereby place the window blind 2 at a desired lowered position.

When it is desired to raise the window blind 2, an external force is applied to push upward the bottom plate 23 so as to reduce the pulling force of the first adjustment cord 44 and change the force-balanced state. That is, the resilient restoring forces of the first elastic members 430 are greater than the pulling force of the first adjustment cord 44 at this time, so that the first elastic members 430 can pull the first slide seats 41 to move away from each other. At this time, the distance between the first pulleys 42 of the first slide seats 41 is increased, and the cord end sections 442 of the first adjustment cord 44 are rapidly wound onto the first pulleys 42 of the first slide seats 41. As the major portions of the cord end sections 442 of the first adjustment cord 44 are wound onto the first pulleys 42 of the first slide seats 41, the bottom plate 23 is pulled upward to raise the blind body 21. After the external force is released, the force-balanced state is restored, and the window blind 2 is placed at a desired raised position.

Using the same principle, when it is desired to place the window blind 2 at any appropriate position, it is only necessary to apply an external force to the bottom plate 23 of the window blind 2. After the appropriate position of the window blind 2 is reached, the external force is then released.

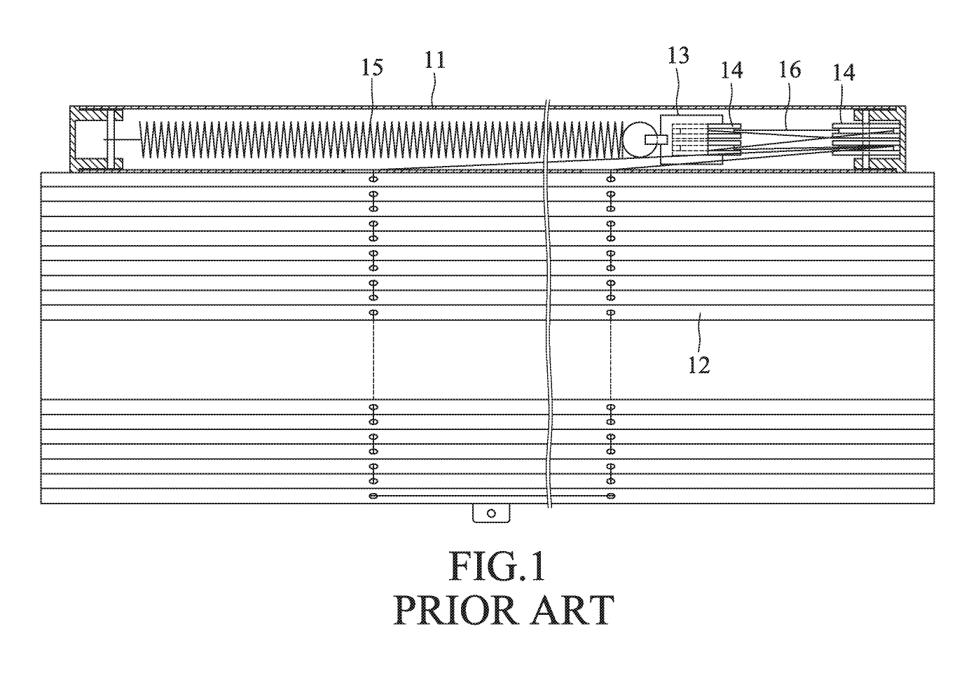

In comparison with the aforesaid prior art which uses only one slide seat 13 (see FIG. 1) , because the sets of first pulleys 42 of this disclosure are mounted respectively and rotatably on the first slide seats 41, the distance between the first slide seats 41 can be doubled during the sliding movement thereof. Thus, the speed of winding or unwinding the first adjustment cord 44 can be accelerated, thereby rapidly adjusting the extended length of the window blind 2. Hence, operation of the window blind 2 is easy, convenient and time-saving.

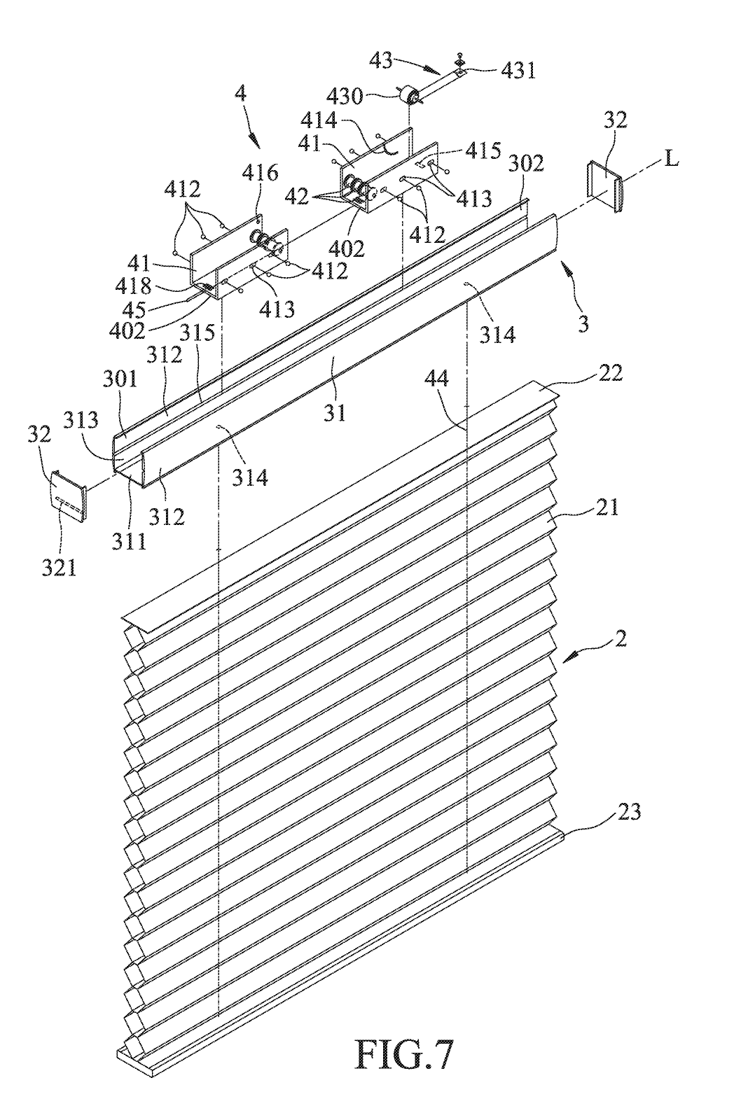

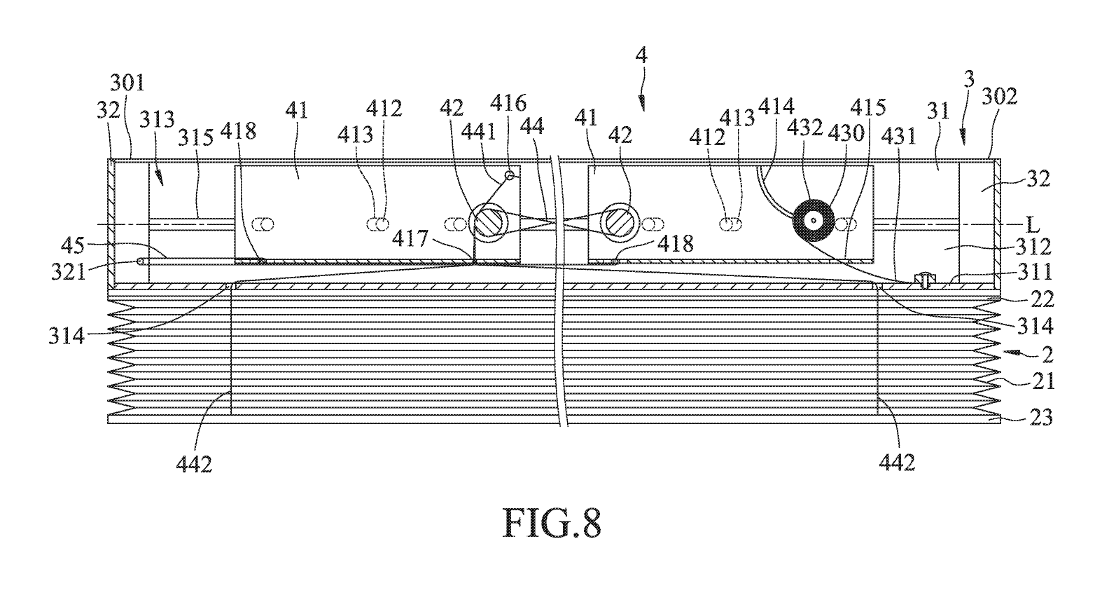

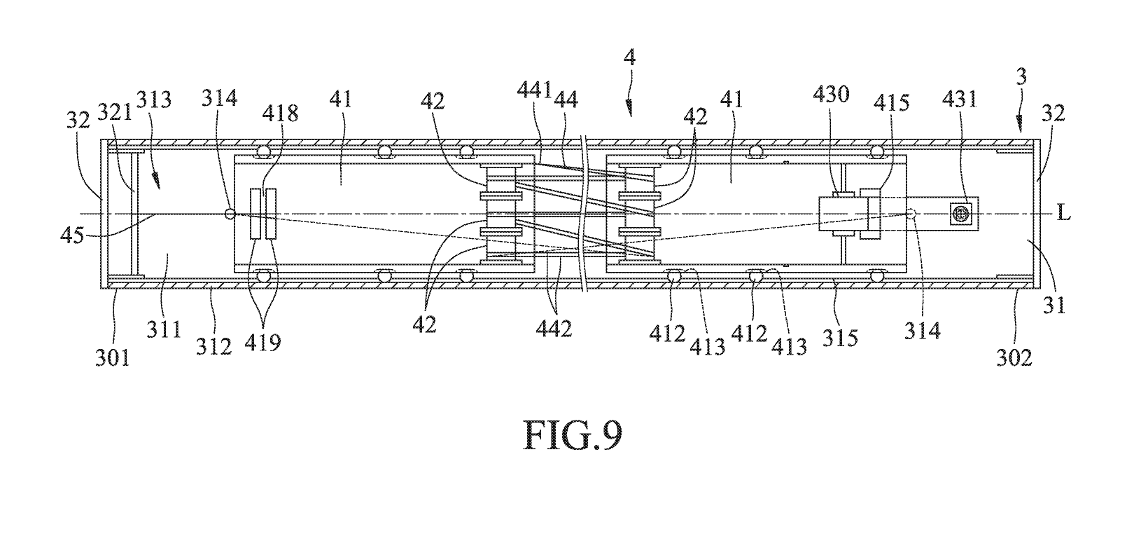

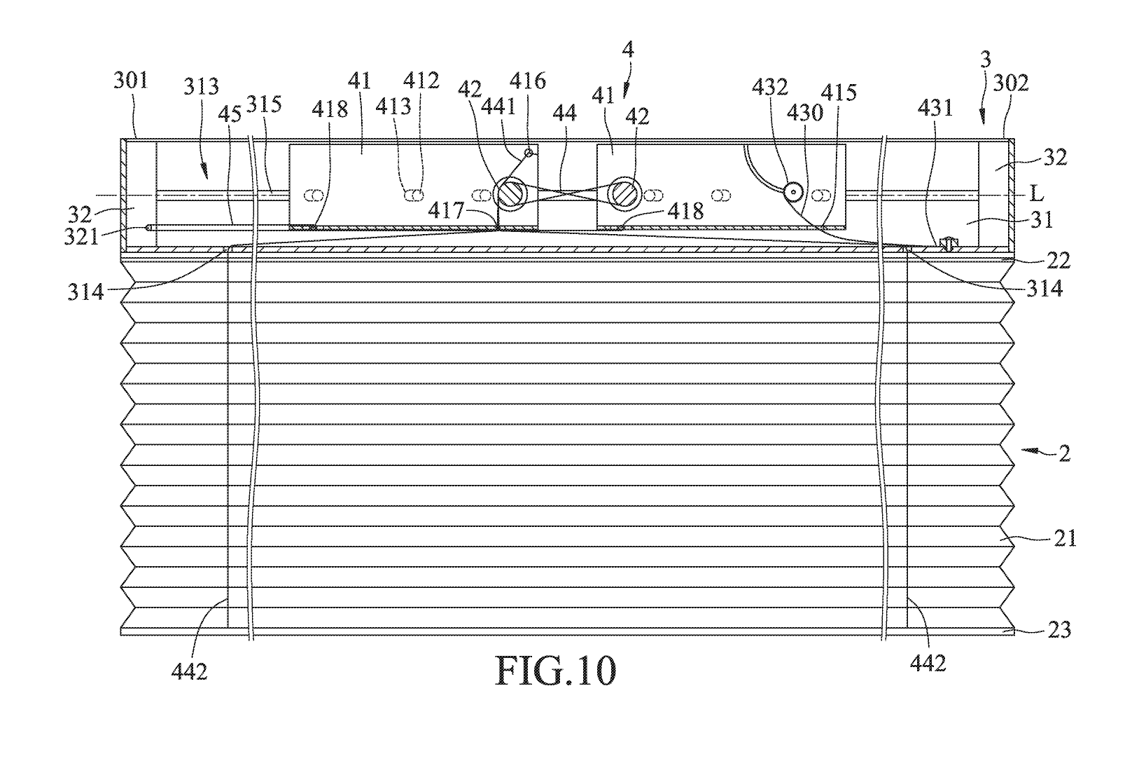

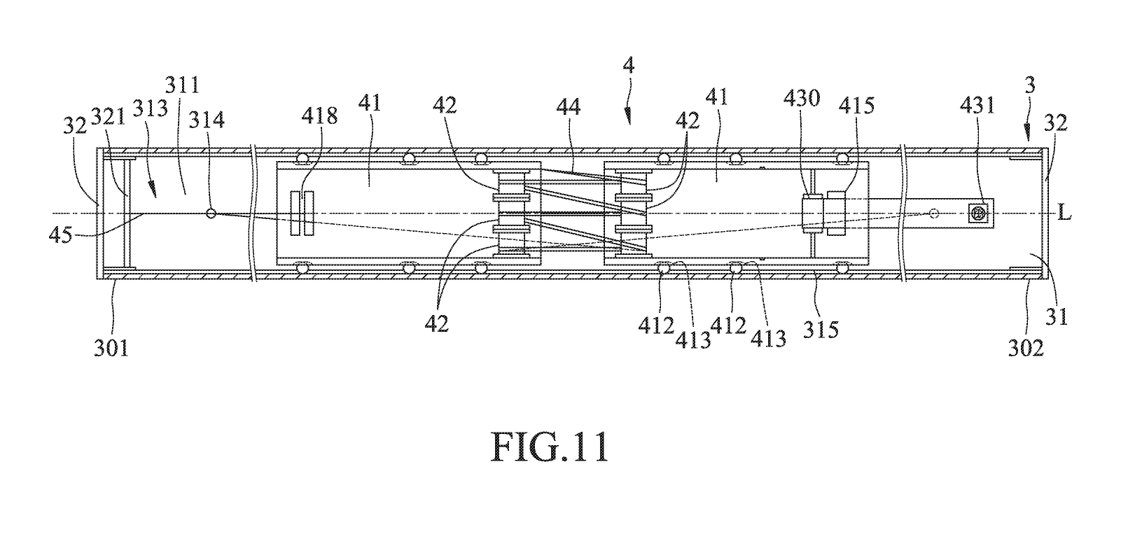

Referring to FIGS. 7 to 11, a cord-winding device according to the second embodiment of the present disclosure is generally identical to the first embodiment. However, in the second embodiment, the first adjustment unit 4 includes only one first elastic unit 43 and further includes a connecting rope 45. The first slide seat 41, which is proximate to the end 302 of the base 31, has a configuration similar to that of the first embodiment. The first slide seat 41, which is proximate to the end 301 of the base 31, is not formed with the engaging grooves 414 (see FIG. 2) and the limiting hole 415 (see FIG. 2). The end cap 32, which covers the end 301, is provided with a transverse rod 321 extending across two opposite sides thereof and transverse to the longitudinal direction (L). The provision of the transverse rod 321 is not limited thereto. In other embodiment, the transverse rod 321 may be provided on one end of the base 31.

The slide bottom wall 402 of each first slide seat 41 is further formed with two adjacent slots 419 and a rib 418 between the two adjacent slots 419. The slots 419 and the rib 418 extend in a direction transverse to the longitudinal direction (L). The slots 419 and the rib 418 of the first slide seat 41 proximate to the end 302 are opposite to the limiting hole 415 along the longitudinal direction (L). The slots 419 and the rib 418 of the first slide seat 41 proximate to the end 301 are opposite to the orifice 416. The connecting rope 45 is looped around the transverse rod 321, and has two opposite ends respectively tied to the ribs 418 of the first slide seats 41. The height and thickness of the transverse rod 321 correspond to the height and thickness of the slide bottom wall 402 of each first slide seat 41 so as to prevent friction between the connecting rope 45 and the first slide seats 41 during movement of the connecting rope 45. In addition, contact between the connecting rope 45 and the first adjustment cord 44 can also be avoided.

The connecting rope 45 is connected to the first slide seats 41 so as to maintain movement of the first slide seats 41 toward or away from each other along the longitudinal direction (L).

The first adjustment cord 44 similarly supports the weight of the window blind 2, and generates a pulling force that pulls the first slide seats 41 to move relative to each other. The first slide seats 41, in turn, pull the first elastic member 430 to generate a resilient restoring force. Although only one first elastic member 430 is provided on one of the first slide seats 41, when the first elastic member 430 is pulled, the connecting rope 45 is used to pull the other first slide seat 41, so that the resilient restoring force of the first elastic member 430 plus the pulling force of the connecting rope 45 counteract the pulling force of the first adjustment cord 44, thereby achieving a force-balanced state.

In use, the operation of the second embodiment is similar to that described in the first embodiment. That is, by applying an external force to push upward or pull downward the bottom plate 23 of the window blind 2, the length of the blind body 21 can be easily and quickly adjusted.

When the bottom plate 23 is pulled downward, the pulling force of the first adjustment cord 44 is increased to resist the resilient restoring force of the first elastic member 430, thereby pulling the first slide seats 41 to move toward each other. With the distance between the first pulleys 42 of the first slide seats 41 being shortened, the cord end sections 442 of the first adjustment cord 44 are rapidly unwound from the first pulleys 42 so as to lower the bottom plate 23 and extend the blind body 21. After the external force is released, the resilient restoring force is again balanced with the pulling force of the first adjustment cord 44, thereby placing the window blind 2 at a desired lowered position.

When the bottom plate 23 is pushed upward, the pulling force of the first adjustment cord 44 is reduced, and the force-balanced state is changed. At this time, the resilient restoring force of the first elastic member 430 is greater than the pulling force of the first adjustment cord 44, so that the first slide seats 41 are pulled away from each other, and the distance between the first pulleys 42 of the first slide seats 41 is increased. As a result, the cord end sections 442 of the first adjustment cord 44 are rapidly wound onto the first pulleys 42 of the first slide seats 41 so as to raise the bottom plate 23 and retract the blind body 21. After the external force is released, the force-balanced state is restored, and the window blind 2 is placed at a desired raised position.

In the second embodiment, the distance between the first pulleys 42 of the first slide seats 41 can also be shortened or increased depending on the sliding movement of the first slide seats 41, so that the speed of winding or unwinding the first adjustment cord 44 can be accelerated. Hence, the extended length of the window blind 2 can be rapidly adjusted, and the effects of time-saving and easy operation of the window blind 2 can be achieved.

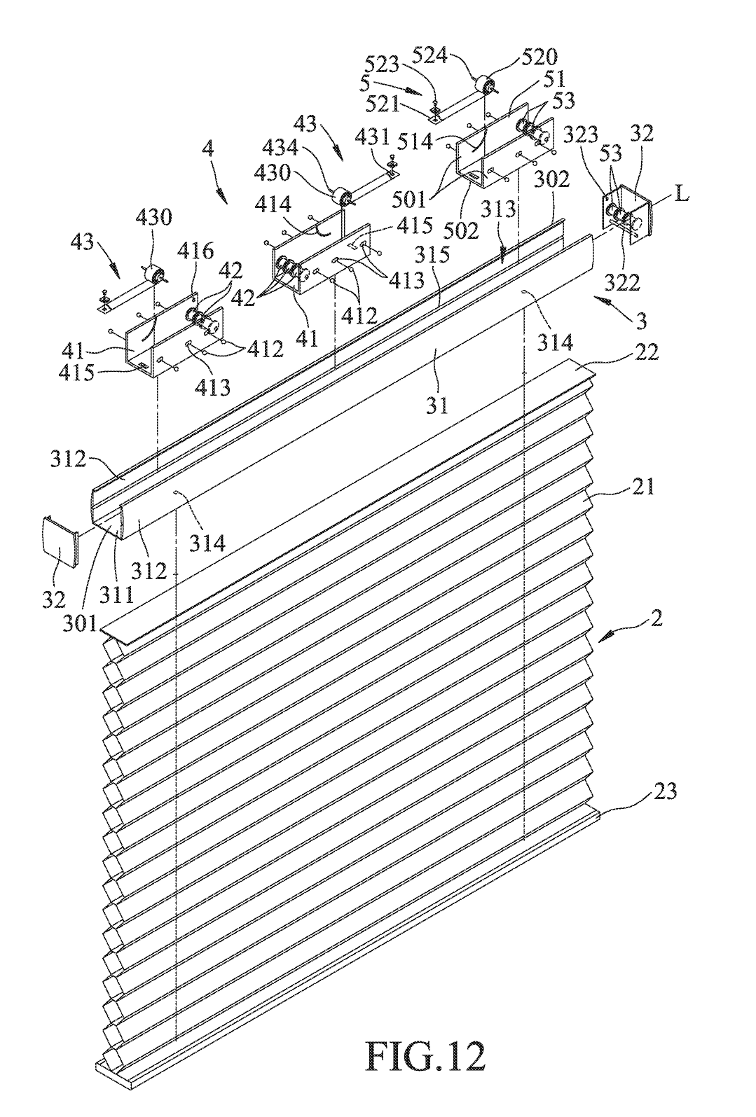

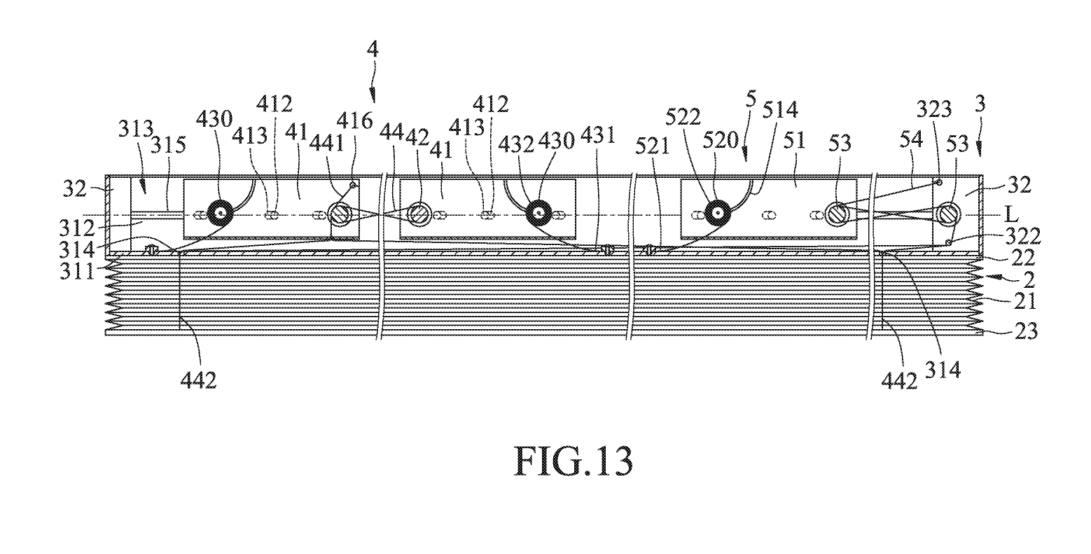

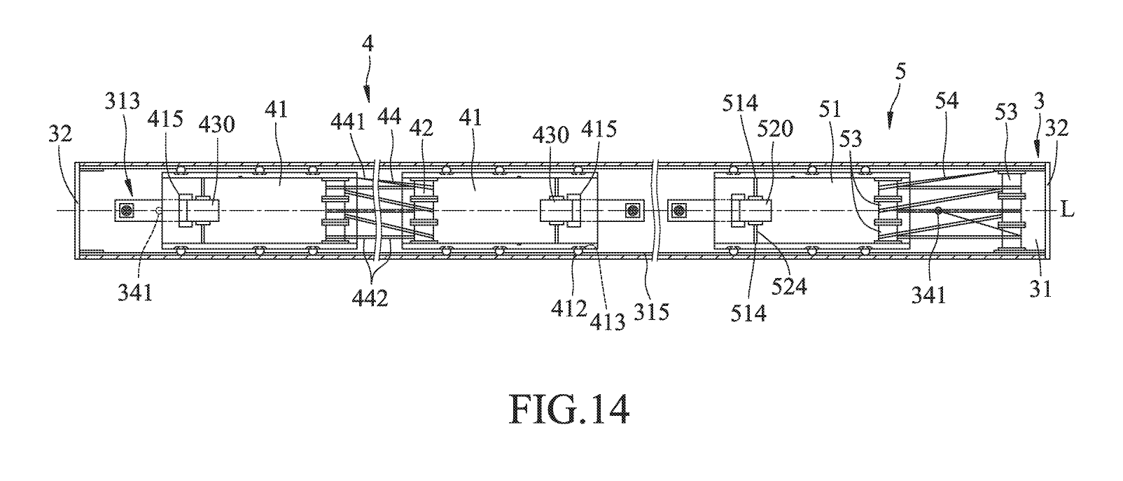

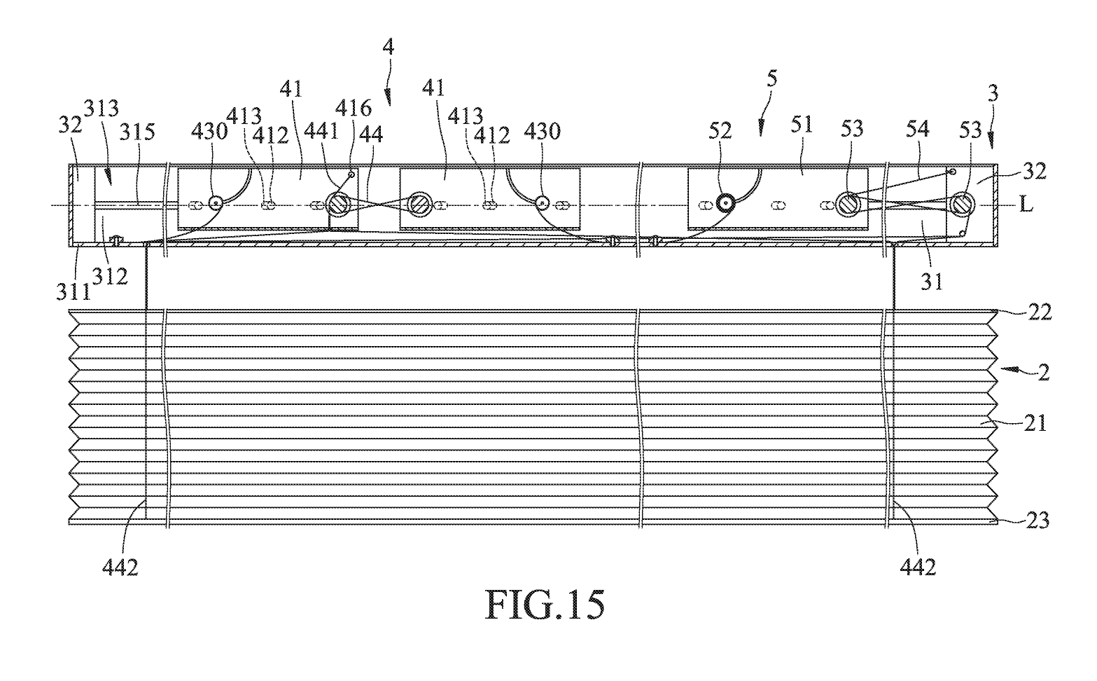

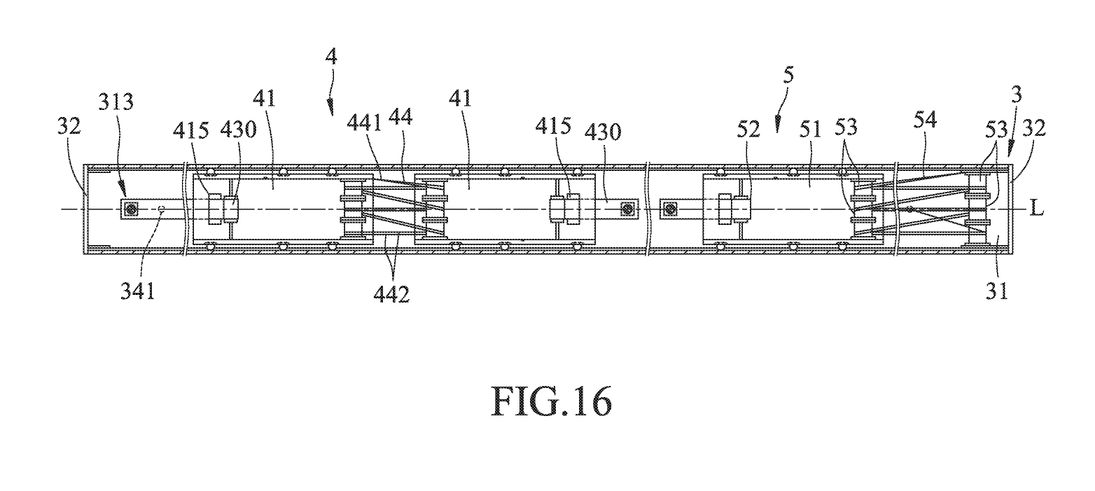

Referring to FIGS. 12 to 16, a cord-winding device according to the third embodiment of the present disclosure is generally identical to the first embodiment. However, the cord-winding device of the third embodiment further comprises a second adjustment unit 5. The second adjustment unit 5 includes a second slide seat 51, a second elastic unit 52, two sets of second pulleys 53 and a second adjustment cord 54. The structures and dispositions of the second slide seat 51 and the second elastic unit 52 are similar to those of the first slide seat 41 and the first elastic unit 43 of the first embodiment. The window blind 2 is driven by the first adjustment cord 44 and the second adjustment cord 54. The top plate 22 is movable relative to the base 31.

The second slide seat 51 and the first slide seats 41 are slidably mounted in the slide channel 313, and are spaced apart from each other along the longitudinal direction (L).

The second elastic unit 52 includes a second elastic member 520, a second fastener 523 and a second pivot shaft 524. The second elastic member 520 is also a constant force spiral spring, and has a first end 521 fixed to the base bottom wall 311 by the second fastener 523, and a second end 522 opposite to the first end 521 and fixed to the second pivot shaft 524. The second pivot shaft 524 has two opposite ends engaged respectively, slidably and rotatably to the engaging grooves 514 in the slide side walls 501 of the second slide seat 51. The second elastic member 520 can be wound or unwound according to the sliding movement of the second slide seat 51.

The two sets of second pulleys 53 are mounted respectively and rotatably on the second slide seat 51 and the end cap 32 which is proximate to the end 302.

In this embodiment, each set of second pulleys 53 includes three second pulleys 53 that are coaxially and rot at ably mounted on the corresponding one of the second slide seat 51 and the end cap 32 proximate to the end 302. The second pulleys 53 on each of the second slide seat 51 and the end cap 32 are disposed side by side in a direction transverse to the longitudinal direction (L). The second pulleys 53 of the second slide seat 51 face the second pulleys 53 of the end cap 32. An insert pin 322 is provided on the end cap 32 below the second pulleys 53, and extends in a direction transverse to the longitudinal direction (L).

The second adjustment cord 54 has one end fixed to an orifice 323 in the end cap 32 above the second pulleys 53 thereof, and is then wound around the sets of second pulleys 53, is looped around the insert pin 322, and is fixed to the top plate 22 after extending out of one of the through holes 314 in the base bottom wall 311. It is worth to mention herein that the positional height of the insert pin 322 is lower than that of the slide bottom wall 502 of the second slide seat 51 to prevent the second adjustment cord 54 from frictionally contacting the second slide seat 51. The second adjustment cord 54 supports a portion of the weight of the window blind 2, and generates a pulling force that pulls the second slide seat 51. The second slide seat 51, in turn, pulls the second elastic member 520 so that the second elastic member 520 generates a resilient restoring force which counteracts the pulling force of the second adjustment cord 54 so as to achieve a force-balanced state. Hence, the movement of the second slide seat 51 is stopped or arrested.

The operation of the second adjustment unit 5 is similar to that of the first adjustment unit 4, and the first and second adjustment units 4, 5 can be operated separately. The first adjustment unit 4 is still used to control the bottom plate 23 of the window blind 2, while the second adjustment unit 5 is used to control the top plate 22 of the window blind 2. The position of a top edge of the blind body 21 can be adjusted by pushing upwardly or pulling downwardly the top plate 22. The adjustment of the top plate 22 is usually made when the bottom plate 23 is in the extended position.

When an external force is applied to move the top plate 22 to an appropriate height, a light blocking position of the blind body 21 can be adjusted. When the top plate 22 is pulled downward, because the downward pulling force is greater than the resilient restoring force, the second slide seat 51 is pulled to move toward the end cap 32 so as to shorten the distance between the sets of second pulleys 53 and to unwind the second adjustment cord 54. As such, the top plate 22 is moved away from the base 31, and light can pass through a space between the top plate 22 and the base bottom wall 311.

On the other hand, when the top plate 22 is pushed upward, because the pulling force of the second adjustment cord 54 is reduced, the resilient restoring force of the second elastic member 520 can pull the second slide seat 51 to move away from the end cap 32 so as to increase the distance between the sets of second pulleys 53 and to wind the second adjustment cord 54 onto the sets of second pulleys 53, thereby pulling the top plate 22 to move toward the base 31 and abut against the base bottom wall 311.

When it is desired to completely retract or raise the window blind 2, the bottom plate 23 is pushed upward, and the first adjustment cord 44 is rapidly wound onto the sets of first pulleys 42. After the blind body 21 is retracted or raised, the top plate 22 can be continuously pushed upward until it abuts against the base bottom wall 311. Hence, the entire window blind 2 is disposed beneath the base unit 3. In view of this, apart from having the effect of rapid winding and unwinding of the first adjustment cord 44 as described in the first embodiment, the third embodiment further has the effect of adjusting the position of the window blind 2 relative to the base unit 3 through the second adjustment unit 5.

From the foregoing, the advantages of the cord-winding device of this disclosure can be summarized as follows:

1) Through the two first slide seats 41 and the two sets of first pulleys 42 mounted respectively and rotatably on the first slide seats 41, the speed of winding and unwinding the first adjustment cord 44 can be enhanced, so that this disclosure is efficient and easy to use.

2) The first elastic members 430 used in this disclosure are constant force springs, which have small volumes and high stability and which do not occupy much space, so that it is easy to assemble and use.

3) Through the configuration of this disclosure in each of the first, second and third embodiments, only an external force exerted by a user's hand is necessary to adjust the extended length and the light blocking position of the window blind 2. After the external force is released, the window blind 2 is located in an appropriate or desired position. The operation of the window blind 2 is rather easy. Further, there is no need for additional provision of a pull cord(s) to control retraction and extension of the blind body 21, so that the hazards associated with using the pull cord can be avoided.

Therefore, the object of this disclosure can be achieved.

In the description above, for the purposes of explanation, numerous specific details have been set forth in order to provide a thorough understanding of the embodiment. It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects.

While the disclosure has been described in connection with what is considered the most practical embodiments, it is understood that this disclosure is not limited to the disclosed embodiments but is intended to cover various arrangements included within the spirit and scope of the broadest interpretation so as to encompass all such modifications and equivalent arrangements.

What is claimed is:

1. A cord-winding device for a window blind, comprising:
a base unit including a base that extends along a longitudinal direction and that defines a slide channel, said base having a bottom surface configured to removably abut against the window blind, said slide channel extending along the length of said base; and
a first adjustment unit including
two first slide seats mounted in said slide channel and slidable toward or away from each other along the longitudinal direction,
two sets of first pulleys mounted respectively and rotatably on said first slide seats,
at least one first elastic unit disposed on one of said first slide seats, and
a first adjustment cord winding around said sets of first pulleys and then extending through said base, said first adjustment cord being configured to be connected to the window blind after extending through said base, and being configured to support the weight of the window blind to thereby generate a pulling force to pull said first slide seats;
wherein, when said first adjustment cord pulls said first slide seats, said first slide seats move toward each other and pull said at least one first elastic unit so as to generate a resilient restoring force that counteracts the pulling force of said first adjustment cord and achieve a force-balanced state; and
wherein, when an external force is applied to the window blind, the force-balanced state is changed for adjusting an extended or retracted length of the window blind.

2. The cord-winding device as claimed in claim 1, wherein said first adjustment unit includes two said first elastic units, said first elastic units being respectively disposed on said first slide seats, each of said first elastic units including a first elastic member, said first elastic members of said first elastic units generating resilient restoring forces that move said first slide seats away from each other and that counteract the pulling force of said first adjustment cord to achieve the force-balanced state.

3. The cord-winding device as claimed in claim 1, wherein said base unit further includes a transverse rod disposed on one end thereof, and said first adjustment unit further includes a connecting rope looped around said transverse rod and having two opposite ends respectively fixed on said first slide seats.

4. The cord-winding device as claimed in claim 1, wherein said base includes a base bottom wall extending along the longitudinal direction and having said bottom surface of said base, and two base side walls extending upwardly and respectively from two opposite lateral ends of said base bottom wall, said base bottom wall and said base side walls cooperating to define said slide channel, said base side walls respectively having slide rails parallel and aligned with each other for said first slide seats to slidably move therealong.

5. The cord-winding device as claimed in claim 4, wherein each of said first slide seats includes two opposite slide side walls, a slide bottom wall connected between bottom ends of said slide side walls, and a plurality of roller balls, each of said slide side walls being formed with a plurality of recesses on an outer surface thereof, said recesses of each of said slide side walls being spaced apart from each other in the longitudinal direction for receiving corresponding ones of said roller balls, said roller balls disposed on said recesses of said first slide seats being rollable along said slide rails of said base side walls to limit sliding movement of said first slide seats along the longitudinal direction.

6. The cord-winding device as claimed in claim 5, wherein said at least one first elastic unit includes a first elastic member that is configured as a constant force spring and that has a first end fixed to said base bottom wall, and a second end opposite to said first end and connected to said one of said first slide seats.

7. The cord-winding device as claimed in claim 6, wherein:
each of said slide side walls of at least one of said first slide seats is further formed with an engaging groove on an inner surface thereof, said engaging grooves of said slide side walls being symmetrically aligned with each other;
said at least one first elastic unit further includes a pivot shaft having two opposite ends engaged respectively, slidably and rotatably to said engaging grooves of said slide side walls of the at least one of said first slide seats;
said second end of said first elastic member is wound around and fixed to said pivot shaft;
said slide bottom wall of the at least one of said first slide seats is formed with a limiting hole;
said first end of said first elastic member extends through said limiting hole and fixed to said base bottom wall.

8. The cord-winding device as claimed in claim 4, wherein a bottom side of one of said first slide seats is formed with a passage hole for extension of said first adjustment cord therethrough.

9. The cord-winding device as claimed in claim 4, the window blind includes a blind body, a top plate disposed on a top edge of the blind body, and a bottom plate disposed on a bottom edge of the blind body, wherein:
said base bottom wall has two through holes extending therethrough in a top-bottom direction transverse to the longitudinal direction and spaced apart from each other along the longitudinal direction; and
said first adjustment cord has a fixed intermediate section, and two cord end sections extending outwardly and respectively from two opposite ends of said fixed intermediate section, said fixed intermediate section being fixed to one of said first slide seats, said cord end sections extending parallel to each other and being wound around said sets of first pulleys and being configured to be fixed to the bottom plate after extending through said passage hole, said through holes, the top plate and the blind body.

10. The cord-winding device as claimed in claim 9, wherein said base unit further includes two end caps respectively covering two opposite longitudinal ends of said base.

11. The cord-winding device as claimed in claim 10, further comprising a second adjustment unit, said second adjustment unit including a second slide seat slidably mounted in said slide channel and spaced apart from said first slide seats, a second elastic unit disposed on said second slide seat, two sets of second pulleys mounted respectively and rotatably on said second slide seat and said base seat, and a second adjustment cord winding around said sets of second pulleys, said second adjustment cord being configured to be fixed to the top plate after extending through one of said through holes in said base bottom wall.

12. The cord-winding device as claimed in claim 11, wherein said second elastic unit includes a second elastic member that is configured as a constant force spring and that has a first end fixed to said base bottom wall, and a second end opposite to said first end of said second elastic member and fixed to said second slide seat.

13. The cord-winding device as claimed in claim 11, wherein said sets of second pulleys are mounted respectively and rot at ably on said second slide seat and one of said end caps, said one of said end caps being provided with an insert pin, said second adjustment cord having one end fixed to said one of said end caps, and the other end that is opposite to said one end and that is configured to be fixed to the top plate after winding around said sets of second pulleys, looping around said insert pin, and then extending through one of said through holes in said base bottom wall.
